(19) United States
(12) Patent Application Publication
(10) Pub. No.: US 2011/0051354 A1
(43) Pub. Date: Mar. 3, 2011

(54) DISK DRIVE MOUNTING APPARATUS

(75) Inventors: CHEN-LU FAN, Tu-Cheng (TW); LI-PING CHEN, Tu-Cheng (TW)

(73) Assignee: HON HAI PRECISION INDUSTRY CO., LTD., Tu-Cheng (TW)

(21) Appl. No.: 12/631,597

(22) Filed: Dec. 4, 2009

(30) Foreign Application Priority Data
Aug. 26, 2009 (CN) 200920308860.6

(51) Int. Cl. G06F 1/16

(52) U.S. Cl. 361/679.33

(57) ABSTRACT

A disk drive mounting apparatus includes an enclosure and a bracket. The enclosure includes a bottom plate and a side plate. Locking posts are located on the side plate. Each locking post includes a head and a neck narrower than the head. The bracket includes two sidewalls for securing a disk drive. A sidewall flange is located on each sidewall. Each sidewall flange defines locking holes. Each locking hole includes a wide portion and a narrow portion smaller than the wide portion. The wide portion can insert the head and the neck therethrough. The narrow portion is configured to slide the neck therein and block the head from inserting back therethrough. The bracket can slide in a direction parallel to the bottom plate, between a first position, where the heads and necks are engaged in the wide portions, and a second position, where the necks are engaged in the narrow portions.

### BACKGROUND

1. Technical Field

The present disclosure relates to a disk drive mounting apparatus.

2. Description of Related Art

Typically, a disk drive bracket is mounted on a computer enclosure using many screws or rivets, which is a very inconvenient process.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric, cutaway view of an embodiment of a mounting apparatus and two disk drives.

FIG. 2 is similar to FIG. 1, but view from another aspect and showing an enclosure in part.

FIG. 3 is an isometric, cutaway view of the enclosure of FIG. 2.

FIG. 4 is an assembled view of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

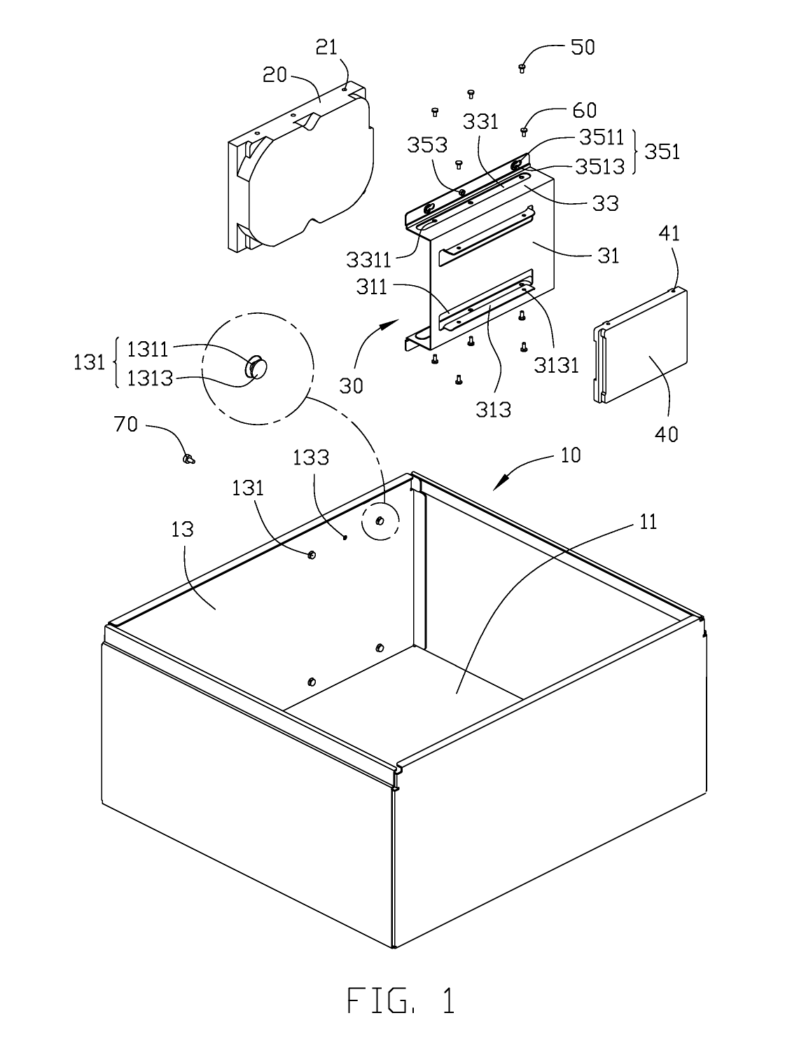

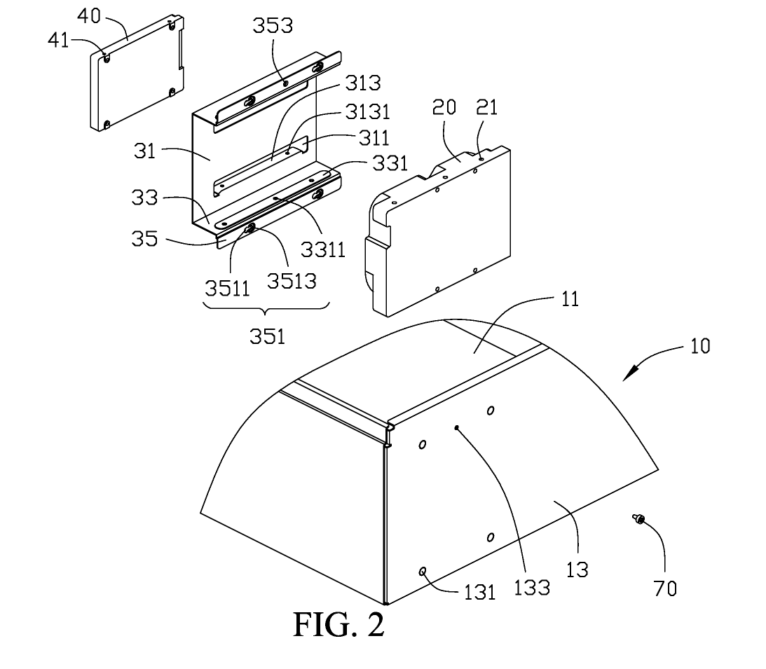

Referring to FIGS. 1-3, a mounting apparatus in accordance with an embodiment includes an enclosure 10 and a bracket 30.

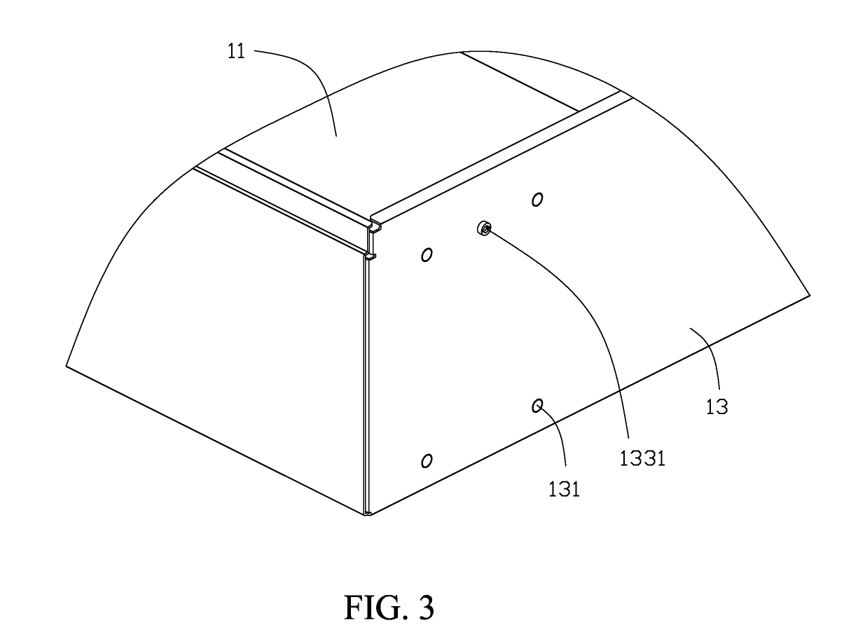

The enclosure 10 includes a bottom plate 11 for securing a motherboard, and a side plate 13 substantially perpendicular to the bottom plate 11. Four hooking stubs 131 protrude from the side plate 13. In one embodiment, the locking posts 131 are arranged in shape of a square. Each locking post 131 includes a head 1313 and a neck 1311 narrower than the head 1313. A positioning post 133 is located on the side plate 13 between two locking posts 131. A positioning hole 1331 (see FIG. 3) is defined in the positioning post 133.

The bracket 30 includes a main wall 31 and two parallel sidewalls 33 substantially perpendicular to the base wall 31. Two parallel rails 313 are located on an outer surface of the base wall 31 and substantially parallel to the sidewalls 33. In one embodiment, a distance between the base wall flanges 313 is shorter than a distance between the sidewalls 33. Each base wall flange 313 defines two mounting holes 3131. A protrusion 331 is located on an inner surface of each sidewall 33. Each protrusion 331 defines three securing holes. Two sidewall flanges 35 are located on the sidewalls 33, and substantially perpendicular to the sidewalls 33 and parallel to the base wall 31. Each sidewall flange 35 defines two locking holes 351. Each locking hole 351 includes a wider portion 3511 configured for receiving the head 1313 of the locking post 131, and a narrower portion 3513 configured for receiving the neck 1311 of the locking post 131 and thus catching the head 1313. A fastening hole 353 is defined in one of the sidewall flange 35 between the two locking holes 351.

A first disk drive 20 is configured to be secured between the sidewalls 33 of the bracket 30. Two longer sidewalls of the first disk drive 20 each defines three installation holes 21. A second disk drive 40 is configured to be secured between the base wall flanges 313. The second disk drive 40 defines two fixing holes 41 in each of two parallel sidewalls.

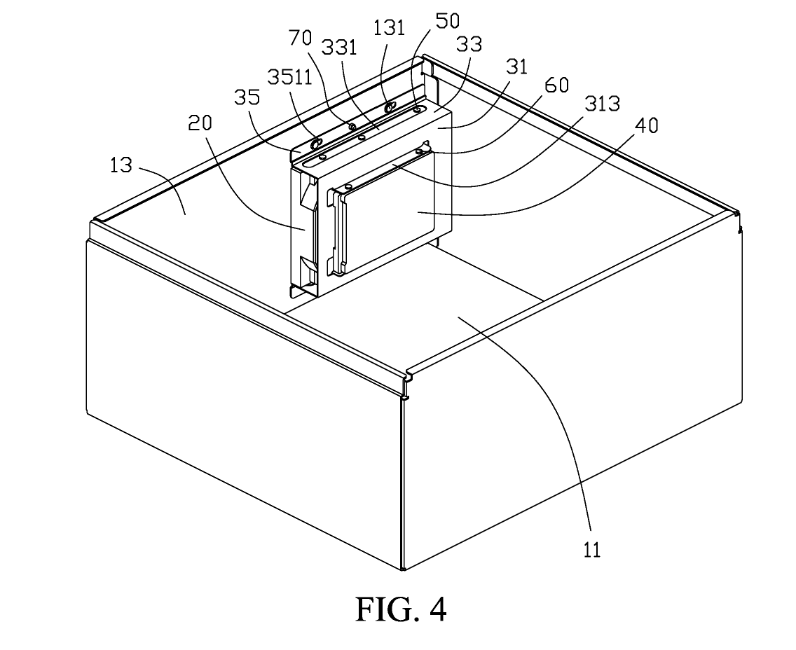

Referring also to FIG. 4, in assembly, the first disk drive 20 is positioned between the sidewalls 33 of the bracket 30, with the first disk drive sidewalls abutting the protrusions 331. The sidewalls 33 are substantially parallel to the side plate 13. The securing holes 3311 are aligned with the installation holes 21, and a plurality of fastening members 50 are fixed into the securing holes 3311 and the installation holes 21 so as to secure the first disk drive 20 between the sidewalls 33 of the bracket 30. The second disk drive 40 is positioned between the base wall flanges 313. The mounting holes 3131 are aligned with the fixing holes 41, and a plurality of fastening members 60 are fixed into the mounting holes 3131 and the fixing holes 41 so as to secure the second disk drive 40 between the base wall flanges 313.

The bracket 30 holding with the first and second disk drives 20, 40 is coupled in the enclosure 10. The bracket 30 is moved to have the heads 1313 of the locking posts 131 inserted through the corresponding wide portions 3511 of the locking holes 351. The bracket 30 is then slid along a direction parallel to the bottom plate 11, so as to slide the necks 1311 into the narrow portions 3513 and align the fastening hole 353 with the positioning hole 1331 of the positioning post 133. A fastening member 70 is secured in the fastening hole 353 and the positioning hole 1331 so as to prevent the bracket 30 from sliding in a reverse direction to disengage the neck 1311 from the narrow portion 3513. Therefore, the bracket 30 together with the first and second disk drives 20, 40 are secured in the enclosure 10.

In one embodiment, the fixing members 50, the mounting members 60, and the fastening members 70 may be screws.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A disk drive mounting apparatus comprising:
an enclosure comprising a bottom plate and a side plate, a plurality of locking posts located on the side plate, and each locking post comprising a head and a neck narrower than the head; and
a bracket comprising two parallel sidewalls configured for securing a disk drive therebetween; a sidewall flange is located on each sidewall; each sidewall flange defines a plurality of locking holes; each locking hole comprises a wide portion and a narrow portion less than the wide portion; the wide portion is configured to receive the head and the neck of the corresponding locking post; and the narrow portion is configured to receive the neck and catch the head;
wherein the bracket can move between a first position, where the heads and necks of the locking posts are engaged in the wide portions of the locking holes, and a second position, where the necks are engaged in the narrow portions; the bracket is slidable between the first and second positions on the side plate along a direction parallel to the bottom plate.

2. The mounting apparatus of claim 1, wherein one of the sidewall flanges defines a fastening hole; the side plate defines a positioning hole; and a fastener is secured in the fastening hole and the positioning hole to prevent the bracket from sliding.

3. The mounting apparatus of claim 2, wherein the fastening hole is positioned between two of the locking holes of the sidewall flange.

4. The mounting apparatus of claim 1, wherein the locking posts are arranged in shape of a square.

5. The mounting apparatus of claim 1, wherein the bracket further comprises a base wall substantially perpendicular to the sidewalls; and two parallel base wall flanges that are perpendicularly located on the base wall and configured to be secured another disk drive.

6. The mounting apparatus of claim 5, wherein a distance between the base wall flanges is less than a distance between the side walls of the bracket.

7. The mounting apparatus of claim 5, wherein the base wall flanges are parallel to sidewalls of the bracket.

8. The mounting apparatus of claim 1, wherein a protrusion is located on an inner surface of each sidewall and configured for abutting the disk drive when secured between the sidewalls of the bracket.

9. A disk drive mounting apparatus comprising:
an enclosure comprising a side plate, a plurality of locking posts located on the side plate, and the side plate defining a positioning hole; and
a bracket comprising two parallel sidewalls configured for securing a disk drive therebetween; a sidewall flange is located on each sidewall; each sidewall flange defines a plurality of locking holes for the locking posts sliding therein; one of the sidewall flanges defines a fastening hole;
wherein the bracket can move between a first position, where the positioning hole offsets from the fastening hole, and a second position, where the positioning hole aligns with the fastening hole; a fastening member is fixed in the positioning hole and the fastening hole to maintain the bracket in the second position.

10. The mounting apparatus of claim 9, wherein each locking post comprises a head and a neck narrower than the head; each locking hole comprises a wide portion and a narrow portion smaller than the wide portion; the wide portion is configured to receive the head and the neck of the corresponding locking post; the narrow portion is configured to slidably receive the neck and catch the head.

11. The mounting apparatus of claim 10, wherein the necks are positioned in the corresponding wide portions when the bracket is in the first position and positioned in the corresponding narrow portions when the bracket is in the second position.

12. The mounting apparatus of claim 9, wherein the locking posts are arranged in shape of a square.

13. The mounting apparatus of claim 9, wherein the bracket further comprises a base wall substantially perpendicular to the sidewalls; two parallel base wall flanges are perpendicularly located on the base wall and configured to be secured another disk drive.

14. The mounting apparatus of claim 13, wherein a distance between the base wall flanges are less than a distance between the side walls of the bracket.

15. The mounting apparatus of claim 13, wherein the base wall flanges are parallel to sidewalls of the bracket.

16. The mounting apparatus of claim 9, wherein the enclosure further comprises a bottom plate substantially perpendicular to the side plate; and the bracket is slidable between the first and second positions along a direction parallel to the bottom plate.
